(19) United States
(12) Patent Application Publication
(10) Pub. No.: US 2011/0195325 A1
(43) Pub. Date: Aug. 11, 2011

(54) HUMIDIFIER MODULE FOR A FUEL CELL SYSTEM

(76) Inventors: Bernd Altmüller, Birkenau (DE); Harald Ehrentraut, Darmstadt (DE); Udo Eping, Darmstadt (DE); Simon Hollnaicher, Uhingen (DE); Peter Wisshak, Baltmannsweiler (DE)

(21) Appl. No.: 13/003,978

(22) PCT Filed: Jul. 8, 2009
(86) PCT No.: PCT/EP09/04927

§ 371 Date: Mar. 21, 2011

(30) Foreign Application Priority Data
Jul. 23, 2008 (DE) 10 2008 034 407.9

(51) Int. Cl. H01M 8/06

(52) U.S. Cl. 429/413

(57) ABSTRACT

The present invention relates to a humidifier module (1) for humidifying a fluid in a fuel cell system of a motor vehicle, with a housing (2) having two housing parts (2a, 2b), wherein a humidifier unit (3) with at least one membrane is arranged between the housing parts (2a, 2b), wherein the humidifier unit (3) is formed in the shape of a single cartridge.

The present invention relates to a humidifier module for humidifying a fluid in a fuel cell system of a motor vehicle, with a housing having two housing parts, wherein a humidifier unit with at least one membrane is arranged between the housing parts.

These humidifier modules are already known in the state of the art. The core of such a humidifier module is a humidifier unit, in which is arranged at least one, and usually a plurality of membranes. The humidifier unit is thereby usually arranged between two housing parts. The interest is presently directed to the construction or design of the humidifier module, especially the housing formed of two housing parts and the humidifier device arranged therebetween, with regard to an arrangement of the humidifier module in an installation space available in the motor vehicle, and with regard to the fulfillment of the system demands.

The specification DE 102 32 757 A1 discloses an apparatus for humidifying a gas flow flowing to a fuel cell system, wherein this gas flow flows through a humidifier device, through which also flows a humid exhaust gas flow from the fuel cell system. This known apparatus further provides a bypass channel (bypass line), through which at least one of the gas flows can be partially guided around a membrane.

The specification DE 102 45 202 A1 discloses a fuel cell stack with a humidifier module for humidifying a fluid flowing to the fuel cell stack. So as to achieve a compact construction, the humidifier module is integrated in an end plate of the fuel cell stack.

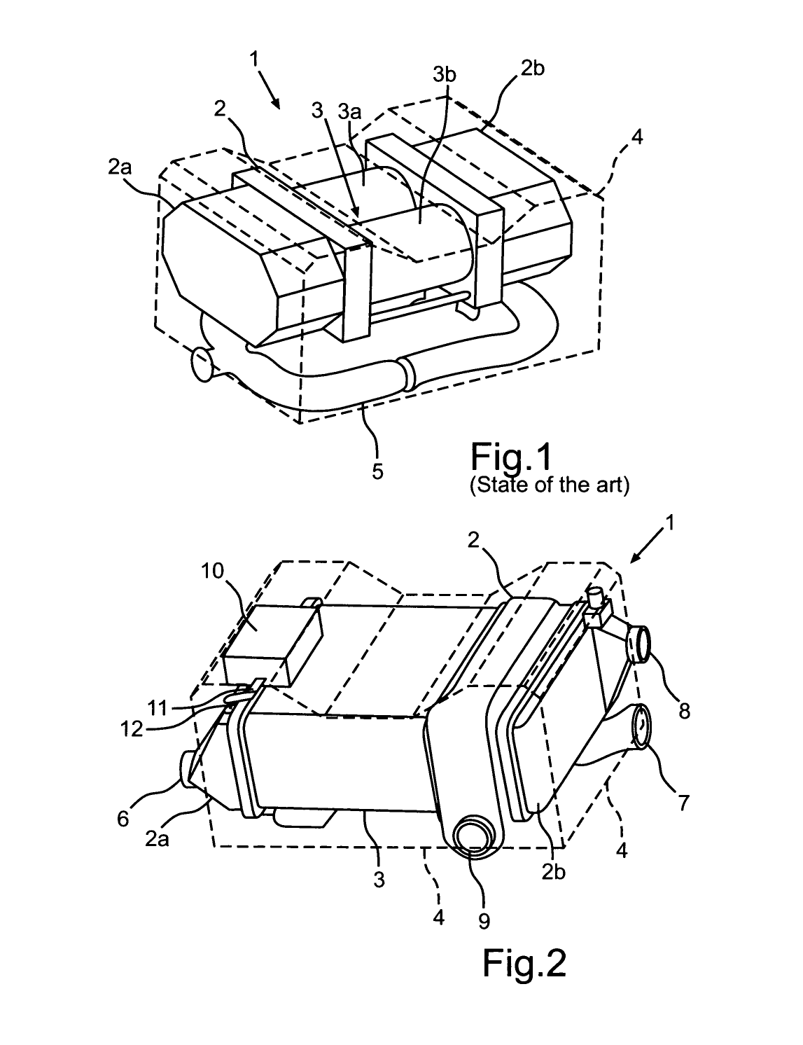

A humidifier module known in the state of the art is shown in FIG. 1. The known humidifier module 1 comprises a housing 2, which consists of two housing parts 2a, 2b. A humidifying unit 3 is arranged between the housing parts 2a, 2b, which has at least one membrane, which is, as known, only permeable to water vapor. In the known humidifier module 1, the humidifying unit 3 is formed by two cartridges 3a, 3b arranged adjacent to one another, which each have at least one membrane.

In FIG. 1 is furthermore shown an installation space 4 for the humidifier module 1 available in the motor vehicle. It shall be mentioned here that the volume of the two cartridges 3a, 3b represents a measure for a humidifying degree of the fluid, and is called effective cartridge volume in the following. As shown in FIG. 1, spacings result in the available installation space 4 by the use of cartridges 3a, 3b having a circular cross section. Due to the spacings resulting from the design of the humidifier unit 3, the available installation space 4 is not used in an optimal manner for the actual function of the humidifier module 1, that is, for the humidification of the fluid, so that a small effective cartridge volume results. The effective volume is 4.5 l in the humidifier module 1 shown in FIG. 1.

The known humidifier module 1 further comprises a bypass channel 5 for bypassing the membrane arranged in the humidifier unit 3. It is achieved by means of the bypass channel 5, that the humidity degree of the fluid to be humidified and the dew point thereof can be adjusted arbitrarily. As shown in FIG. 1, the bypass channel 5 having a circular cross section is guided around the housing 2 of the humidifier module 1. A disadvantage of a suboptimal use of the available installation space is also present here, so that a large effective cartridge volume cannot be achieved.

It is an object of the present invention to provide a humidifier module for humidifying a fluid in a fuel cell system, where a volume of an available installation space as large as possible is used for the function of humidifying the fluid.

This object is solved according to the invention by a humidifier module with the characteristics of claim 1. Advantageous designs of the invention are given in the dependent claims.

A humidifier module according to the invention is formed for humidifying a fluid in a fuel cell system of a motor vehicle. The humidifier module comprises a housing which has two housing parts, wherein a humidifier unit with at least one membrane is arranged between the housing parts. According to the invention, the humidifier unit is formed by a single cartridge.

In other words, it is a basic idea of the invention to design the humidifier module, and especially the humidifier unit arranged between the housing parts with regard to achieving a maximum volume used for the humidification of the fluid in such a manner, that only one single cartridge with at least one membrane arranged therein is provided between the housing parts. In an advantageous manner, an installation space available in the motor vehicle is hereby used in a better manner for the actual function of the humidifier module, that is, for humidifying the fluid, than for example when using two or more cartridges.

The single cartridge preferably has a cross section deviating from a circle, preferably an angular, especially preferred a rectangular cross section. It can further be provided that the single cartridge has a cross section adapted to the cross section of the two housing parts. The installation space available in the motor vehicle can hereby be used in a better manner. Especially by using a cross section adapted to the cross sections of the two housing parts of the single cartridge, it is achieved that no spacings or no unused spaces result. The term “cross section” here is especially meant to be an outer cross section or an outer contour of a cross section profile.

In one embodiment, a bypass channel for bypassing the at least one membrane is integrated in the humidifier module. It has been shown to be especially advantageous if the bypass channel has a cross section deviating from a circle, preferably an angular, especially preferred a rectangular cross section. The effective cartridge volume can be increased further by the integration of the bypass channel in the humidifier module. It is particularly provided that the bypass channel is formed in the shape of a flat channel and abutting an inner wall of the housing of the humidifier module. It can alternatively be provided that the bypass channel formed as a flat channel is guided around and abutting the housing of the humidifier module.

A control element for changing a cross section of the bypass channel which can be flown through is arranged in the bypass channel in a preferred manner. The control element is thereby preferably formed in the shape of a throttle valve. By the use of the control element, an adjustability of the fluid flowing through the bypass channel is achieved, so that the humidity degree of the fluid to be humidified can be varied arbitrarily. By the use of a throttle valve, the geometry of which is particularly adapted to an inner geometry or an inner contour or an inner cross section of the bypass channel, the adjustability is further enabled in a technically simple manner. It can further be provided thereby, that the control element can be driven by an actuator, which is arranged at and/or in the humidifier module. The actuator can be an electric, a pneumatic, or a hydraulic actuator.

Further advantages, characteristics and details of the invention result from the following description of a preferred embodiment, and by means of the added drawings.

It shows thereby:

FIG. 1 a humidifier module according to the state of the art in perspective; and

FIG. 2 a humidifier module according to a preferred embodiment of the present invention in perspective.

The embodiment explained in more detail in the following shows a preferred embodiment of the present invention.

The same elements or elements with the same functionality are provided with the same reference numerals in the figures.

A humidifier module 1 shown in FIG. 2 is formed for humidifying a fluid in a fuel cell system of a motor vehicle. The humidifier module 1 comprises a housing 2, which has at least two housing parts 2a, 2b. The humidifier module 1 further comprises a humidifier unit 3 arranged between the housing parts 2a, 2b, in which a plurality of membranes is arranged. The humidifier unit 3 is presently formed by a single cartridge.

The humidifier module presently serves for humidifying air, which is provided to the fuel cell system as oxidation means for example from a fan. For this, the humidifier module 1 comprises an air supply 6, via which the fresh air is supplied from the fan to the humidifier module 1. The humidifier module 1 further comprises an exhaust gas connection 7, via which an exhaust gas from the fuel cell system having product water is supplied to the humidifier module 1. The product water present in the exhaust gas, especially water vapor, is thus used for humidifying the air necessary for the electrochemical reaction. The exhaust gas supplied via the exhaust gas connection 7 now flows via the humidifier module 1 and discharges its humidity via the membranes to the dry air supplied via the air supply 6. The air humidified in this manner can now be supplied to the fuel cell system as oxidation means via fuel cell connection 8 of the humidifier module 1. The exhaust gas fed to the humidifier module 1 via the exhaust gas connection 7 is finally removed from the humidifier module 1 via an outlet connection 9.

The humidifier module 1 further comprises a bypass channel (not shown), by means of which the membranes arranged in the humidifier unit 3 can be bypassed. By this, it is made possible to guide the air originating from the fan to the fuel cell connection 8 without humidifying it. So as to adjust a humidity degree of the air provided for the fuel cell system, and a dew point thereof, the humidifier module 1 further comprises a control element for changing a cross section of the bypass channel which can be flown through. The control element is formed as a throttle valve and is integrated in the bypass channel. The throttle valve can be driven by means of an actuator 10 arranged at the housing 2 of the humidifier module 1. The actuator 10 thereby drives the throttle valve via a drive element 11, which is connected to a pin-shaped part 12 of the throttle valve.

As is shown in FIG. 2, the single cartridge 3 has an essentially rectangular cross section, which is adapted to cross sections of the two housing parts 2a, 2b. An optimal use of the installation space 4 available for the humidifier module 1 available in the motor vehicle results hereby. Only with the use of a single cartridge 3, the effective cartridge volume can be maximised, that is, a volume, which is used for the actual function of the humidifier module 1, that is, for humidifying the air.

The bypass channel further has an essentially rectangular cross section in the present example and is arranged in the humidifier module 1 abutting an inner wall of the housing 2. The effective cartridge volume can be increased further by the arrangement of the bypass channel within the housing 2.

It is to be mentioned here that, within the scope of the present embodiment, the air supply 6, the fuel cell connection 8, the exhaust gas connection 7, and the outlet connection 9 respectively have a circular cross section profile. The diameter of the air supply 6 and of the fuel cell connection 8 are respectively 40 mm, and the diameter of the exhaust gas connection 7 and the outlet connection 9 are respectively 50 mm. If a length of the single cartridge 3 of 300 mm is assumed, a width of 260 mm, and a height of 115 mm, an effective volume of the single cartridge of 9 l results. If alternatively a length of 300 mm is assumed, a width of 250 mm, and a height of 115 mm, an effective volume of the single cartridge 3 of 8.6 l results. In addition to the improved use of the available installation space 4, an improved dew point of the air to be humidified results by the use of a single cartridge 3. A dew point of about 75° C. is aimed for in the present embodiment. Further advantages can be achieved by the integration of the bypass channel in the housing 2. The rigidity of the housing 2 can for example be improved by the sandwich structure caused due to the integration.

### LIST OF REFERENCE NUMERALS

1 Humidifier module
2 Housing
2a, 2b Housing parts
3 Humidifier unit/cartridge
4 Installation space
5 Bypass channel
6 Air supply
7 Exhaust gas connection
8 Fuel cell connection
9 Outlet connection
10 Actuator
11 Drive element
12 Pin-shaped part

1. Humidifier module for humidifying a fluid in a fuel cell system of a motor vehicle, with a housing, which comprises two housing parts,
wherein a humidifier unit with at least one membrane is arranged between the housing parts,
wherein the humidifier unit is formed by a single cartridge.

2. Humidifier module according to claim 1, wherein the single cartridge has a cross section, especially an outer cross section, deviating from a circle.

3. Humidifier module according to claim 1, wherein the single cartridge has an angular, especially rectangular cross section.

4. Humidifier module according to claim 1, wherein the single cartridge has a cross section adapted to a cross section of the two housing parts.

5. Humidifier module according to claim 1, wherein a bypass channel for bypassing the at least one membrane is integrated in the humidifier module.

6. Humidifier module according to claim 5, wherein the bypass channel has a cross section deviating from a circle, especially a rectangular cross section.

7. Humidifier module according to claim 5, wherein a control element for changing a cross section of the bypass channel which can be flown through is arranged in the bypass channel.

8. Humidifier module according to claim 7, wherein the control element is formed as a throttle valve.

9. Humidifier module according to claim 7, wherein the control element can be driven by an actuator, which is arranged at and/or in the humidifier module.
